(19) United States
(12) Patent Application Publication
(10) Pub. No.: US 2026/0205366 A1
(43) Pub. Date: Jul. 16, 2026

(54) CONFIGURING NETWORK SETTINGS WITH AUGMENTED REALITY

(71) Applicant: Saudi Arabian Oil Company, Dhahran (SA)

(72) Inventors: Nada Essa Al Noaimi, Dhahran (SA); Ali Mohammed Alaali, Safwa (SA)

(21) Appl. No.: 19/018,235

(22) Filed: Jan. 13, 2025

(51) Int. Cl. H04L 41/14; G06T 19/00; H04L 41/22

(52) U.S. Cl. CPC H04L 41/145; G06T 19/006; H04L 41/22

(57) ABSTRACT

A method for configuring components of a network infrastructure that includes determining a component of the network infrastructure, in which the component is associated with values of configuration data. The method includes generating an augmented reality representation of the component of the network infrastructure, in which the augmented reality representation includes the component, the values of the configuration data of the component, and one or more connections between the component and other components of the network infrastructure. The method includes overlaying the augmented reality representation on a camera feed, the camera feed associated with a camera of a user device, receiving an instruction to modify the values of the configuration data of the component, and sending an instruction to modify the values of the configuration data of the component.

### TECHNICAL FIELD

The present disclosure relates to configuring settings of network infrastructure components.

### BACKGROUND

Network infrastructure is a critical foundation that supports the flow of data and communication across a wide array of digital platforms and devices. As global communication continues to expand as well as smaller scale private networks, the infrastructure that underpins these networks must evolve and maintain reliability to handle the increasing demands for speed and scalability. The complexity of network systems has grown significantly, driven by the need to support diverse applications, from everyday internet browsing to advanced cloud computing and IoT ecosystems. Ensuring smooth operation and continuous improvement of these networks is essential for maintaining the seamless exchange and processing of information.

### SUMMARY

This disclosure describes techniques that include displaying a digital representation of a network infrastructure on a display through an augmented reality (AR) program, receiving instructions to modify configuration data of a network component, and sending commands that result in a change in component configuration data. The techniques further include displaying a simulated network infrastructure on the display through the AR program.

Implementations of the systems and methods of this disclosure can provide various technical benefits. A digital interactive representation of network infrastructure through AR enables network technicians to remotely view and monitor the health and configuration of network components. In addition, the digital interactive representation enables network technicians and network administrators to model security threats on simulated networks to test the effectiveness of proposed modifications. Further, the digital interactive representation enables training of network professionals to configure and monitor real network infrastructure by interacting with simulated network infrastructure.

In a first aspect, a method for configuring components of a network infrastructure, in which the method includes determining a component of the network infrastructure, in which the component is associated with values of configuration data. The method includes generating an augmented reality representation of the component of the network infrastructure. The augmented reality representation includes the component, the values of the configuration data of the component, and one or more connections between the component and other components of the network infrastructure. The method includes overlaying the augmented reality representation on a camera feed. The camera feed is associated with a camera of a user device. The method includes receiving an instruction to modify the values of the configuration data of the component and sending an instruction to modify the values of the configuration data of the component.

In some implementations, generating the augmented reality representation of the component of the network infrastructure is performed on a server remote from the user device. In some implementations, the method includes establishing a persistent connection between the server and the user device, wherein the server monitors security information associated with a plurality of components of the network infrastructure.

In some implementations, the method includes transmitting, by the server to the user device, a notification in response to a security event. In some implementations, the notification includes information about the security event and a list of one or more remediation options.

In some implementations, the method includes transmitting, by the server to the user device, updated configuration data associated with the component of the network infrastructure.

In some implementations, the method includes determining multiple components of the network infrastructure, in which each component is associated with a respective configuration data.

In some implementations, the method includes generating an augmented reality representation of the components of the network infrastructure. The augmented reality representation includes each component of the plurality of components, the respective configuration data of each component, and one or more connections between each component and other components of the network infrastructure.

In some implementations, the method includes generating an augmented reality representation of a simulated network infrastructure.

In some implementations, the component of the network infrastructure is remote from the user device.

Is another aspect, a system for configuring components of a network infrastructure, in which the system includes at least one processor, and a memory storing instructions that, when executed by the at least one processor, cause the at least one processor to perform operations that include determining a component of the network infrastructure, in which the component is associated with values of configuration data. The operations include generating an augmented reality representation of the component of the network infrastructure. The augmented reality representation includes the component, the values of the configuration data of the component, and one or more connections between the component and other components of the network infrastructure. The operations include overlaying the augmented reality representation on a camera feed. The camera feed is associated with a camera of a user device. The operations include receiving an instruction to modify the values of the configuration data of the component and sending an instruction to modify the values of the configuration data of the component.

In some implementations, generating the augmented reality representation of the component of the network infrastructure is performed on a server remote from the user device. In some implementations, the operations include establishing a persistent connection between the server and the user device, wherein the server monitors security information associated with a plurality of components of the network infrastructure.

In some implementations, the operations include transmitting, by the server to the user device, a notification in response to a security event. In some implementations, the notification includes information about the security event and a list of one or more remediation options.

In some implementations, the operations include transmitting, by the server to the user device, updated configuration data associated with the component of the network infrastructure.

In some implementations, the operations include determining multiple components of the network infrastructure, in which each component is associated with a respective configuration data.

In some implementations, the operations include generating an augmented reality representation of the components of the network infrastructure. The augmented reality representation includes each component of the plurality of components, the respective configuration data of each component, and one or more connections between each component and other components of the network infrastructure.

In some implementations, the operations include generating an augmented reality representation of a simulated network infrastructure.

In some implementations, the component of the network infrastructure is remote from the user device.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of an example network infrastructure display system.

FIG. 2 is a schematic view of an example network infrastructure display system.

FIG. 3 is a schematic view of an example network infrastructure display and simulation system.

FIG. 4 is a flow diagram of an example process for modifying a configuration parameter of a network infrastructure component.

FIG. 5 is a diagram of an example computing system.

Like reference numbers and designations in the various drawings indicate like elements.

### DETAILED DESCRIPTION

This disclosure describes techniques that can be used for monitoring and modifying configurations (such as by modifying configuration data) of network infrastructure components. Rather than requiring a technician to manually debug network infrastructure security and reliability issues in person or on a component-by-component basis, the systems and processes described in this disclosure enable remote monitoring and configuration of components using an augmented reality (AR) system (e.g., an AR interface) and real-time or near real-time security notifications. In this case, real-time or near real-time security notifications refer to notifications related to detected security vulnerabilities associated with a current (i.e., within a period of time) configuration of at least one network infrastructure component. Based on a digital representation of network infrastructure components, the systems and methods can determine if mitigation steps should be implemented in real-time or near real-time in relation to particular network components. For example, a user can shut down or quarantine one or more components of a network infrastructure responsive to a detection of a security threat.

A data processing system (or other processing hardware operating the AR system) is configured to receive information indicative of a network infrastructure. For example, the information includes information about components of the network, configuration data for each component, and information indicative of data paths between the components of the network. Based on the information, the data processing system, through the AR interface, generates a digital and interactive representation of the network to be displayed by an AR program. In some implementations, the AR program, such as an application, is executed by a user device (e.g., a smartphone, wearable device, etc.). The AR program causes the user device to display the digital representation and enables the user device to receive input from a user. In some implementations, the input includes an instruction to modify configuration data, such as network access control settings, in relation to a particular component of the network. In addition, the user can view network security and reliability information through the AR program. The user, using the AR interface, can test mitigation strategies on a simulated network component before sending an instruction to modify the configuration data on the deployed, corresponding network component.

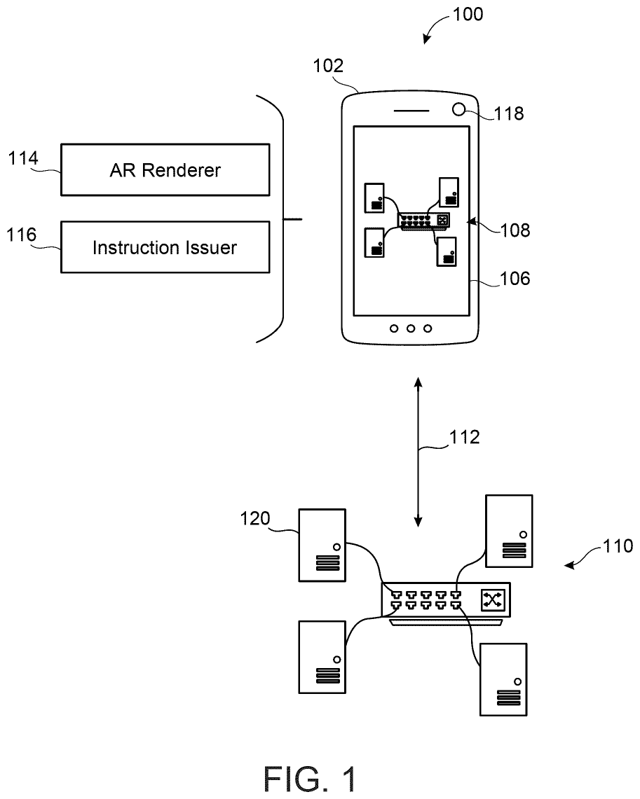

FIG. 1 is a schematic view of an example network infrastructure display system 100. The system 100 includes a device 102 that includes at least a processor, a network interface, and a display 106. The device 102 implements operations including an AR renderer 114 (e.g., an AR program implemented on the device 102) and an instruction issuer 116.

In some implementations, the device 102 is a mobile device. The mobile device can include a tablet/smartphone, a desktop/laptop computer, wearable device, or other computing device with a display, or computing devices communicatively coupled with a display. In some implementations, the device 102 is any handheld or wearable device with access to a camera, motion sensors, and a suitable wireless connection. The device is communicatively coupled with at least one component of a network infrastructure 110. In this disclosure, the at least one component of the network infrastructure 110 is referred to as receiver 120. In some implementations, the receiver 120 includes a processor that executes operations associated with configuration and monitoring logic and is communicatively coupled with other components of the network infrastructure 110. The receiver 120 can access configuration settings and modify configuration settings of components of the network infrastructure 110. The network infrastructure 110 includes multiple computing devices, switches, routers, antenna, transmitters/transceivers, etc. The network infrastructure 110 can be a subset of the internet, a private intranet, or any other logical grouping of network components.

The device 102 is communicatively coupled through a data path 112 to the receiver 120. The data path 112 can transfer signals indicative of modified configuration settings associated with components of the network infrastructure 110 from the device 102 to the receiver 120. In some implementations, the data path 112 includes one or more intermediate servers, routers, or other components that facilitates a transfer of data between the device 102 and the receiver 120. In some implementations, a network interface included in the device 102 facilitates a transfer of information between the device 102 and the receiver 120.

The device 102 includes the display 106. In some implementations, the display 106 and the associated processor of the device 102 are local. In this disclosure, local devices and/or components refer to elements disposed on a common physical device. In some other implementations, the display 106 and the associated processor are remote. In this disclosure, remote devices and/or components refer to elements disposed on separate physical devices with a communication channel between the elements. The device 102 includes a camera 118. In some implementations, the camera 118 includes at least one lens, at least one light detector, and the associated processor includes image processing software. In some implementations, the camera 118 is remote from the device 102 and the image data collected by the camera 118 is transmitted to the device 102 for processing and/or display.

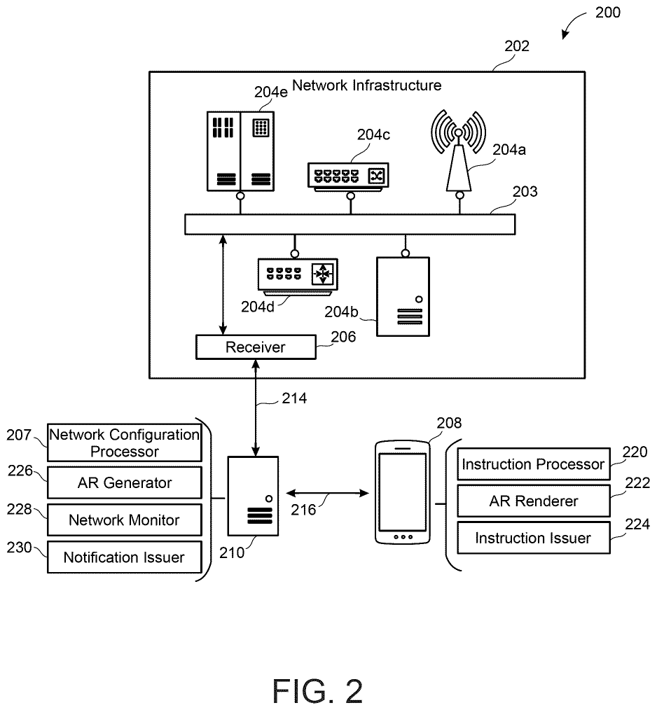

The processor of the device 102 executes operations associated with the AR renderer 114. The device 102 processes AR content (received from a server, as described in relation to FIG. 2), and renders the AR content on a camera feed of the device 102. The AR content can include a three-dimensional representation of the components of the network infrastructure 110. In some implementations, components of the device 102 render the AR content via a web browser with access to a JavaScript engine. In some implementations, the camera feed is a data feed associated with the camera 118. In some implementations, the camera feed is associated with a remote camera and the camera feed is displayed on the display 106. The display 106 displays a digital representation 108 of the network infrastructure 110. The digital representation 108 includes information about components of the network infrastructure 110, configuration settings of the respective components, security assessments, detected threats, and other useful monitoring and/or configuration information related to components of the network infrastructure 110.

The digital representation 108 is an AR representation of the network infrastructure 110 overlayed on the camera feed of the camera 118. The AR representation of the network infrastructure 110 refers to a digital representation of components of the network infrastructure 110 of a virtual depiction of the components that is overlaid onto a real world image captured by the camera 118. For example, using an AR program executed by a processor of the device 102, a user can point the camera 118 of the device 102 at a specific location in their environment to view and interact with the virtual representation. The environment does not necessarily include any component of the network infrastructure 110. The user device 102 can be remote from all components of the network infrastructure 110.

The processor and other hardware components (e.g., a network interface) of the device 102 execute operations associated with the instruction issuer 116. The instruction issuer 116 receives instructions, as described in relation to FIG. 2, and issues the instructions to the receiver 120. In some implementations, the instruction issuer 116 can communicate with a network interface of the device 102 to transmit a message through the data path 112 to the receiver 120 that is indicative of a modified configuration of a particular component of the network infrastructure 110. For example, the digital representation 108 can indicate a security vulnerability associated with a particular router of the network infrastructure 110. The instruction issuer 116 can receive an instruction from a user or instruction processor and issue a message via the data path 112 to the receiver 120 to modify one or more configuration settings of the particular router to mitigate the associated security threat.

In some implementations, the instruction issuer 116 receives instructions from a user. For example, the instructions can represent an action that includes modifying access control settings associated with a component of the network infrastructure. In some implementations, the instruction issuer 116 receives instructions based on gesture-based or touchscreen commands through a user interface of the device 102. As another example, the instructions can represent an action that includes implementing real-time quarantine measures on compromised component by selecting the compromised component via the AR representation of the network infrastructure 110. In some implementations, the instructions can include a directive for one or more automated measures to be executed by the system. As another example, the instructions can represent an action that includes simulating changes to network infrastructure configurations. As such, the system can re-route data communication paths for determining potential impacts in a controlled, virtual environment before applying the changes to the physical implementation of the network infrastructure. As a further example, the instructions can represent an action that includes generating and executing configuration scripts through an AR overlay of the camera 118, eliminating a need for manual command-line entries in a computing environment.

FIG. 2 is a schematic view of an example network infrastructure display system 200. The system includes a network infrastructure 202. The network infrastructure 202 includes a network of components. These components can include a transmitter/transceiver 204a, a server 204b, a switch 204c, a router 204d, and a mainframe 204e. The components of the network infrastructure 202 are coupled through data paths 203 of a network topology. Each component of the network infrastructure 202 is communicatively coupled to at least one other component of the network infrastructure 202.

In some implementations, the network infrastructure 202 includes at least one receiver 206. In the example of FIG. 2, the receiver 206 and associated logic is implemented by a processor and network interface of a server that enables the receiver 206 to be communicatively coupled to at least one component of the network infrastructure 202 via the data paths 203. In some cases, the receiver 206 is communicatively coupled via the data paths 203 to each of the components, either directly or indirectly, of the network infrastructure 202.

The system 200 includes a control server 210. The control server 210 is communicatively coupled to the user device 208 through data path 216 and with at least the receiver 206 of the network infrastructure 202 through data path 214. The data path 214 and the data path 216 are two-way communication channels between respective devices.

The control server 210 implements operations associated with a network configuration processor 207. The network configuration processor 207 receives instructions from the user device 208 and/or an automated instruction generator to modify one or more configuration settings of a component of the network infrastructure 202. For example, an instruction can be indicative of an access control setting of a particular router of the network infrastructure 202. The control server 210 transmits a message via data path 214 to the receiver 206 indicative of the instruction. The receiver 206 processes the message and implements operations to follow the instruction by changing the access control setting of the particular router of the network infrastructure 202. In some implementations, the receiver 206 processes the message and implements operations associated with quarantining measures on compromised devices by selecting the devices through a user interface (e.g., an AR interface). In some implementations, in response to receiving the message, the receiver 206 simulates changes to network configurations (e.g., rerouting data paths), to determine potential impacts to the network in a controlled and virtual environment before applying the changes to the physical network infrastructure.

Components of the network infrastructure 202 can include internet of things (IoT) gateways. The network configuration processor 207 can configure device authentication protocols and data transmission schedules in relation to an IoT gateway. In addition, the network infrastructure 202 can include cloud access points, in which the network configuration processor 207 can adjust encryption standards and/or network bandwidth allocation policies. Furthermore, the network infrastructure 202 can include telecommunication new radio Fifth Generation (5G) base stations, in which the network configuration processor 207 can fine-tune signal distribution parameters and optimizing user device prioritization algorithms. As another example, the network infrastructure 202 can include industrial control systems (ICS), in which the network configuration processor 207 manages communication latency thresholds and failover mechanisms for critical applications.

The control server 210 implements operations associated with a network monitor 228. The network monitor 208 receives data in relation to the components of the network infrastructure 202 via data path 214 from the receiver 206 and processes the data. In some examples, the network monitor 208 processes the data to determine an existence of security threats, downtime, and other characteristics of components of the network infrastructure 202. The control server 210 transmits the processed data by the network monitor 228 to the user device 208.

The control server 210 implements operations associated with a notification issuer 230. The notification issuer 230 can process information from the network monitor 208 and issue notification to the user device 208 in relation to security threats, configuration recommendations, etc. The notifications can be displayed on the user device 220.

The control server 210 implements operations associated with an AR generator 226. The AR generator 226 processes information representative of the components of the network infrastructure 202 and generates a three dimensional digital representation of the components. The AR generator 226 includes physical connects of the components, configuration settings of the components, and overall health and security assessments of the components of the network infrastructure 202. The control server 210 transmits information generated by the AR generator 226 to the user device 208.

The user device 208 includes a processor and other hardware components for implementing operations associated with an instruction processor 220. The instruction processor 220 receives instructions from a user or other automated systems to be transmitted to the control server 210 via the data path 216 via operations associated with an instruction issuer 224. In some implementations, a user of the device 208 initiates a request for a modified configuration setting of a component of the network infrastructure 202. The instruction processor 220 receives the request from the user and generates an instruction to transmit to the control server 210 and associated network configuration processor 207 via the instruction issuer 224.

In some implementations, the instruction processor 220 receives instructions through gestures, text, interaction with a user interface, and data from an associated camera feed. In some implementations, the camera feed is from a camera integrated with the user device 208. In some other implementations, the camera is from a camera external from and communicatively coupled to the user device 208.

The user device 208 includes a processor and other hardware components for implementing operations associated with an AR render 222. The user device 208 receives data generated by the AR generator 226 of the control server 210 and renders the three dimensional graphical representation of the network infrastructure 202 on a display of the user device 208. In some implementations, the AR renderer 222 overlays the graphical representation of the network infrastructure 202 on the camera feed of the user device 208.

In some implementations, the data path 216 can include a direct connection between the user device 208 and the control server 210. For example, a Bluetooth connection. In some implementations, the data path 216 includes one or more servers or network devices that relay messages between the user device 208 and the control server 210. The data path 216 is a two-way communication channel that transmits instructions from the user device 208 and the control server 210 and transmits network monitoring data between the control server 210 and the user device 208. In general, each data path depicted in FIG. 2 can be a direct connection or an indirect connection including multiple intermediate devices. In addition, each data path depicted in FIG. 2 is a two-way data path.

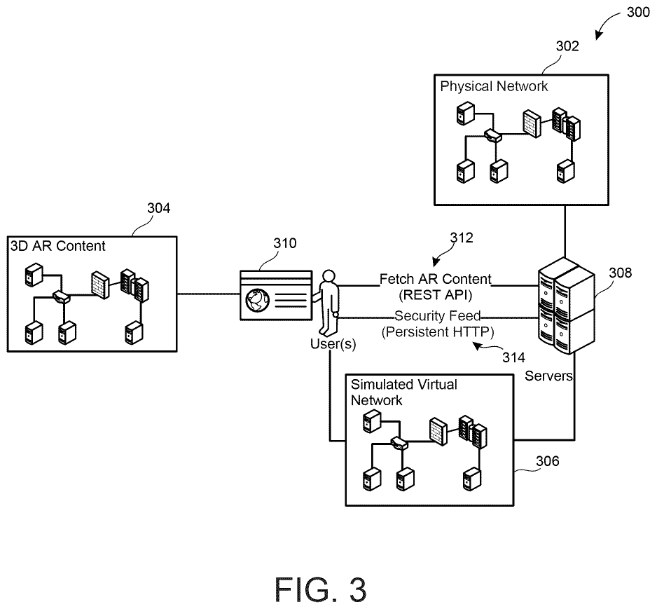

FIG. 3 is a schematic view of a network infrastructure display and simulation system 300. The system 300 includes a physical network infrastructure 302, an AR digital representation 304 of the physical network infrastructure 302, an AR simulated digital representation 306 of the network infrastructure 302, one or more servers 308, and a user interface 310. In some implementations, the one or more server 308 is a single server. In some other implementations, the operations executed by the one or more servers 308 are distributed between multiple servers.

The physical network infrastructure 302 includes multiple network devices and associated configuration parameters, as described in relation to FIG. 2. The server 308 is communicatively coupled to at least one device of the network 302. The server 308 implements operations associated with a continuous security scanning procedure to monitor and assess the health of the network 302 and associated components. The servers 308 implement operations associated with a deployment of configuration and policy changes of components of the network 302.

In some implementations, a server detects a security threat, and also initiates one or more mitigation steps in response to the detection of the security threat. In some implementations, the mitigation steps take the form of an automated threat response. When immediate action is critical (e.g., a security threat), such as isolating a compromised networking device to prevent malware propagation through the network, the server 308 can apply pre-determined remediation protocols in response. In addition, for complex mitigation scenarios that require strategic decision making by a networking professional, the server 308 can receive inputs from the professional (e.g., through user-guided network infrastructure changes), provide notification to the professional, and offer recommendations for mitigation strategies to the professional through a communication channel or a user interface.

In some implementations, the server 308 can initiate one or more notifications (e.g., alarms) via a notification engine. In some cases, the server 308 generates multi-tiered alerts. For example, the server 308 can output visual overlays in the AR simulated digital representation 306 that highlight affected network components in real-time (e.g., within a particular time frame after an event has occurred), such as flashing markers overlayed on compromised routers. In addition, the server 308 can generate detailed threat summaries (e.g., on the AR simulated digital representation 306) that include a threat type, affected endpoints (e.g., routers), and suggested mitigations in response to the detected threats (such as shutting a system down or quarantining the system or device). Furthermore, the server 308 can provide auditory and/or haptic feedback to a user to ensure the user remains aware of high-priority threats, especially in visually intensive environments (e.g., simulated environments with many simulated networking devices).

In some implementations, the server 308 is communicatively coupled with networking devices via a persistent connection that transmits a live stream of data to and provides visualization on the AR simulated digital representation 306. The live camera feed enables a visual inspection of identified hardware issues and assists in remediation decisions via an interactive AR interface. The persistent connection ensures that network health metrics, alerts, and changes are reflected on the representation 306 for observation. The server 306 can display the alerts using layered data views, in which users can toggle between types of threat information (e.g., active attacks), performance metrics (e.g., bandwidth usage), and configuration options (e.g., firewall rules). Additionally, the server 306 can render dynamic overlays in which security alerts are visually coded by severity (e.g., yellow for warnings and red for critical issues). Linked remediation options (such as system shut down, quarantine, etc.) can be displayed with corresponding user interface buttons for each visualized threat.

In some implementations, the server 308 implements operations to capture a network image for virtualization. The network image includes a digital representation of the components of the physical network infrastructure 302, connections between each component, and configuration settings of each component and communication channel. The network image for virtualization if processed by a server, e.g., the control server 210 of FIG. 2, to generate an AR digital representation of the network infrastructure 302.

The AR digital representation 304 reflects the network image received by the server 308 based on the physical network infrastructure 302. In some implementations, the servers 308 implement instructions to generate AR content based on the network image. A user device implements the user interface 310 and displays a rendered representation of the AR content 304 for viewing and interaction by a user. In some implementations, the AR content 304 is rendered in a browser's JavaScript engine over a camera's live feed. In some implementations, multiple users can interact with the AR digital representation 304 with multiple independent devices simultaneously.

The server 306 generates the AR content 304 dynamically through virtualization processes. The virtualization processes include data aggregation, in which the system collects real-time data on physical network topology (networking devices and associated data communication channels between them), device states, and connection health between networking components. In addition, the virtualization process includes AR mapping, in which networking data is transformed into detailed 3D models, in which the 3D models include networking components (e.g., routers and switches) as labeled, interactive objects represented in the AR digital representation 304. Furthermore, the virtualization process includes generation of a physical overlay, in which the virtual objects generated during the AR mapping are positioned in the AR interface (e.g., the AR digital representation 304 displayed on the user interface 310) according to the relative spatial position and connections of each component in the physical network and displayed over a live camera feed of a user device. For example, a virtual router can be highlighted in orange in the AR digital representation 304, which indicates the router is nearing maximum traffic capacity. In some cases, real-time bandwidth metrics are displayed above the virtual router on the AR digital representation 304. Furthermore, a red line can be displayed between a firewall and a server in the AR digital representation 304 which indicates a detected intrusion attempt through the firewall to the server.

A user device that includes the user interface 310 is communicatively coupled with the server 308 through a first data path 312 from the user device to the servers 308 and a second data path 314 from the servers 308 to the user device. The data paths 312-314 are also depicted in FIG. 2 as the data path 216. The data path 312 can represent a request via an application programming interface (API) between the user device and the servers 308. The request can include a message indicative of a request for AR content in relation to the AR digital representation 304. The data path 314 can represent a persistent connection between the servers 308 and the user device 310 that transmits a security feed, e.g., relevant security information in relation to the components of the physical network infrastructure 302.

The AR simulated digital representation 306 of the network infrastructure 302 is displayed on the user interface 310. Similar to the AR digital representation 304, the AR simulated digital representation 306 includes a digital representation of the physical network 302 generated by processes implemented by the servers 308. However, the simulated digital representation 306 is indicative of a simulated environment, whereas the digital representation 304 is indicative of the real (e.g., real-time or near real-time) state of the physical network infrastructure 302. For example, the simulated digital representation 306 represents a simulated environment with synthetic data to enable training and/or learning activities for network administrators.

In some implementations, the system includes multiple distinct operational modes. For example, a user can view a live monitoring mode, in which the AR simulated digital representation 306 represents a real-time visualization of network status and alerts. As another example, the user can view a simulated thread modeling mode, in which users can generate hypothetical attack scenarios on a virtual twin of the network to experiment with mitigation strategies while not affecting the physical devices of the network. As another example, a user can view a training mode, in which a simulated environment that represents real networking infrastructure allows network administrators to practice response procedures and configuration changes without putting a live physical network at risk. As another example, a user can view a mixed mode, in which the mixed mode is a hybrid mode that overlays live data (e.g., from real networking devices) with simulation insights. The mixed mode provides a “what-if” analysis (e.g., based on real data that corresponds to a physical devices, determine what would happen if a particular change would be made to the network).

The servers 308 can create a virtual network infrastructure that mimics the physical network infrastructure 302. In some cases, the virtual network infrastructure simulates failures and/or disaster recovery scenarios, allowing trainees to deploy configuration and policy changes without affecting components of the physical network infrastructure 302. In some cases, for each digital representation 304 generated by processes of the servers 308, the servers 308 generate a simulated environment for testing, troubleshooting, and training. In some implementations, a user interacts with the simulated digital representation 306 via the same user interface 310 as the interaction with the digital representation 304. In some implementations, the simulated digital representation 306 represents data stored on the servers 308.

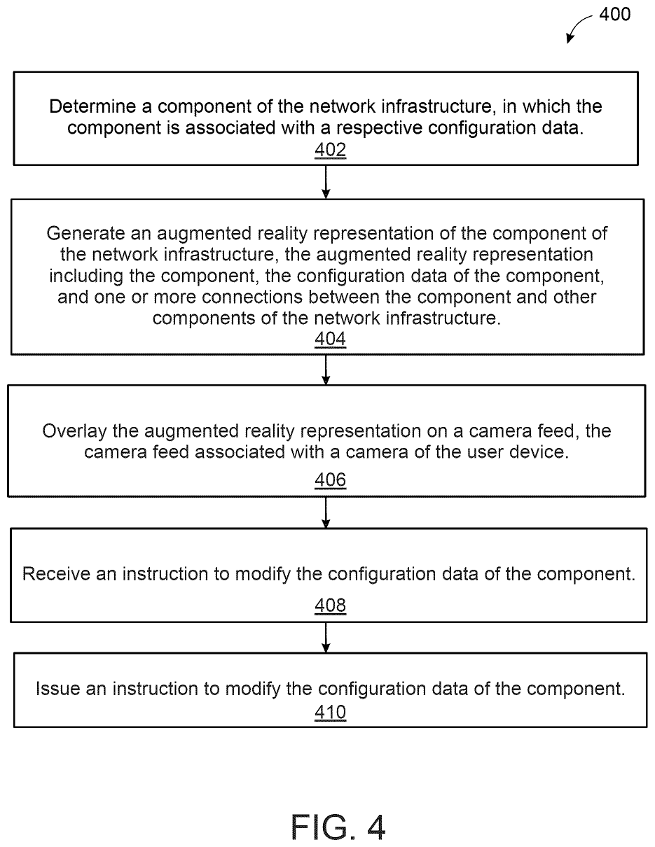

FIG. 4 is a flow diagram of an example process for modifying a configuration parameter of a network infrastructure component. For clarity of presentation, the description that follows generally describes process 400 in the context of the other figures in this description. In some implementations, various steps of process 400 can be performed in parallel, in combination, in loops, or in any order. One or more steps of process 400 can be performed by the system 200, also referred to as the system in the description below.

The system determines (402) a component of the network infrastructure, in which the component is associated with values of configuration data. In some implementations, each network component is associated with multiple values of configuration data. For example, a network component can be associated with network access control data, network port configuration data, firewall data, etc. Network infrastructure components can include servers, routers, switches, and other networking devices.

The system generates (404) an augmented reality representation of the component of the network infrastructure. The augmented reality representation includes the component, the values of the configuration data of the component, and the connections between the component and other components of the network infrastructure. In some implementations, the augmented reality representation is a three-dimensional visual representation of the network infrastructure components and connections between them.

The system overlays (406) the augmented reality representation on a camera feed. The camera feed is associated with a camera of a user device. In some implementations, a user of the user device views the camera feed and can interact with representation of the network infrastructure components through hand gestures and other interactive modes.

The system receives (408) an instruction to modify the values of the configuration data of the component. In some implementations, a user provides an input to the user device through a user interface or through a captured gesture through the camera feed. The system issues (410) issues an instruction to modify the values of the configuration data of the component. In some implementations, the user device and associated programs, e.g., a networking interface communicatively coupled with one or more components of a network infrastructure through an application programming interface, can initiate a modification of values of configuration data associated with components of the network infrastructure.

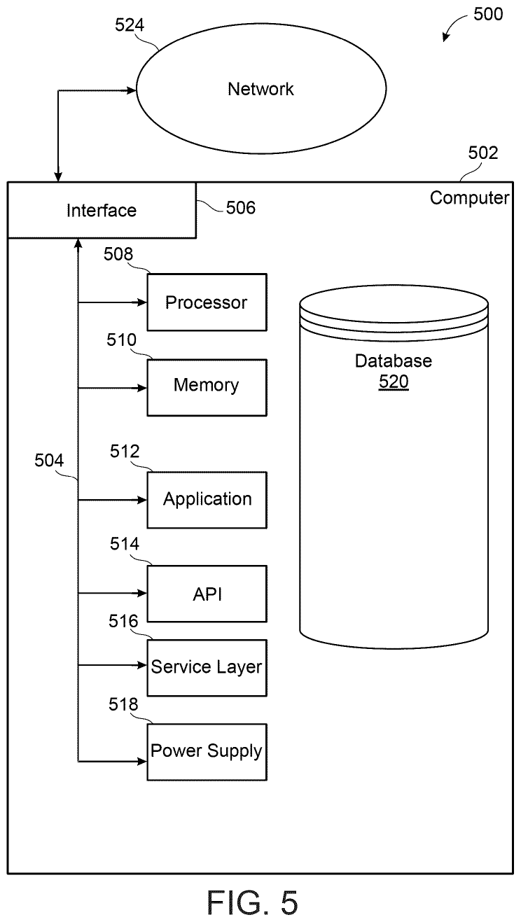

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 524. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 524 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 504. In some implementations, any or all of the components of the computer 502, including hardware or software components, can interface with each other or the interface 506 (or a combination of both), over the system bus 504. Interfaces can use an application programming interface (API) 514, a service layer 516, or a combination of the API 514 and service layer 516. The API 514 can include specifications for routines, data structures, and object classes. The API 514 can be either computer-language independent or dependent. The API 514 can refer to a complete interface, a single function, or a set of APIs.

The service layer 516 can provide software services to the computer 502 and other components (whether illustrated or not) that are communicably coupled to the computer 502. The functionality of the computer 502 can be accessible for all service consumers using this service layer. Software services, such as those provided by the service layer 516, can provide reusable, defined functionalities through a defined interface. For example, the interface can be software written in JAVA, C++, or a language providing data in extensible markup language (XML) format. While illustrated as an integrated component of the computer 502, in alternative implementations, the API 514 or the service layer 516 can be stand-alone components in relation to other components of the computer 502 and other components communicably coupled to the computer 502. Moreover, any or all parts of the API 514 or the service layer 516 can be implemented as child or sub-modules of another software module, enterprise application, or hardware module without departing from the scope of the present disclosure.

The computer 502 includes an interface 506. Although illustrated as a single interface 506 in FIG. 5, two or more interfaces 506 can be used according to implementations of the computer 502 and the described functionality. The interface 506 can be used by the computer 502 for communicating with other systems that are connected to the network 524 (whether illustrated or not) in a distributed environment. Generally, the interface 506 can include, or be implemented using, logic encoded in software or hardware (or a combination of software and hardware) operable to communicate with the network 524. More specifically, the interface 506 can include software supporting one or more communication protocols associated with communications. As such, the network 524 or the interface's hardware can be operable to communicate physical signals within and outside of the illustrated computer 502.

The computer 502 includes a processor 508. Although illustrated as a single processor 508 in FIG. 5, two or more processors 508 can be used according to implementations of the computer 502 and the described functionality. Generally, the processor 508 can execute instructions and can manipulate data to perform the operations of the computer 502, including operations using algorithms, methods, functions, processes, flows, and procedures as described in the present disclosure.

The computer 502 also includes a database 520 that can hold data for the computer 502 and other components connected to the network 524 (whether illustrated or not). For example, database 520 can be in-memory or a database storing data consistent with the present disclosure. In some implementations, database 520 can be a combination of two or more different database types (for example, hybrid in-memory and conventional databases) according to implementations of the computer 502 and the described functionality. Although illustrated as a single database 520 in FIG. 5, two or more databases (of the same, different, or combination of types) can be used according to implementations of the computer 502 and the described functionality. While database 520 is illustrated as an internal component of the computer 502, in alternative implementations, database 520 can be external to the computer 502.

The computer 502 also includes a memory 510 that can hold data for the computer 502 or a combination of components connected to the network 524 (whether illustrated or not). Memory 510 can store any data consistent with the present disclosure. In some implementations, memory 510 can be a combination of two or more different types of memory (for example, a combination of semiconductor and magnetic storage) according to implementations of the computer 502 and the described functionality. Although illustrated as a single memory 510 in FIG. 5, two or more memories 510 (of the same, different, or combination of types) can be used according to implementations of the computer 502 and the described functionality. While memory 510 is illustrated as an internal component of the computer 502, in alternative implementations, memory 510 can be external to the computer 502.

The application 512 can be an algorithmic software engine providing functionality according to implementations of the computer 502 and the described functionality. For example, application 512 can serve as one or more components, modules, or applications. Further, although illustrated as a single application 512, the application 512 can be implemented as multiple applications on the computer 502. In addition, although illustrated as internal to the computer 502, in alternative implementations, the application 512 can be external to the computer 502.

The computer 502 can also include a power supply 518. The power supply 518 can include a rechargeable or non-rechargeable battery that can be configured to be either user- or non-user-replaceable. In some implementations, the power supply 518 can include power-conversion and management circuits, including recharging, standby, and power management functionalities. In some implementations, the power-supply 518 can include a power plug to allow the computer 502 to be plugged into a wall socket or a power source to, for example, power the computer 502 or recharge a rechargeable battery.

There can be any number of computers 502 associated with, or external to, a computer system including the computer 502, with each computer 502 communicating over network 524. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Implementations of the subject matter and the functional operations described in this disclosure can be implemented in digital electronic circuitry, in tangibly embodied computer software or firmware, in computer hardware, including the structures disclosed in this disclosure and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this disclosure can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this disclosure contains many specific implementation details, these should not be construed as limitations on the scope of what may be claimed, but rather as descriptions of features that may be specific to implementations. Certain features that are described in this disclosure in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Several embodiments of these systems and methods have been described. Nevertheless, it will be understood that various modifications may be made without departing from the scope of this disclosure. Accordingly, other embodiments are within the scope of the following claims.

### Examples

In some implementations, methods for configuration components of a network infrastructure include determining a component of the network infrastructure, in which the component is associated with values of configuration data. The methods include generating an augmented reality representation of the component of the network infrastructure. The augmented reality representation includes the component, the values of the configuration data of the component, and one or more connections between the component and other components of the network infrastructure. The methods include overlaying the augmented reality representation on a camera feed. The camera feed is associated with a camera of a user device. The methods include receiving an instruction to modify the values of the configuration data of the component and sending an instruction to modify the values of the configuration data of the component.

In an example implementation combinable with any other implementation, the generating the augmented reality representation of the component infrastructure is performed on a server remote from the user device.

In an example implementation combinable with any other implementation, the methods include establishing a persistent connection between the server and the user device. The server monitors security information associated with components of the network infrastructure.

In an example implementation combinable with any other implementation, the methods include transmitting, by the server to the user device, a notification in response to a security event.

In an example implementation combinable with any other implementation, the notification includes information about the security event and a list of one or more remediation options.

In an example implementation combinable with any other implementation, the methods include transmitting, by the server to the user device, updated configuration data associated with the component of the network infrastructure.

In an example implementation combinable with any other implementation, the methods include generating an augmented reality representation of the components of the network infrastructure, the augmented reality representation including each component of the components, the respective configuration data of each component, and one or more connections between each component and other components of the network infrastructure.

In an example implementation combinable with any other implementation, the methods include generating an augmented reality representation of a simulated network infrastructure.

In an example implementation combinable with any other implementation, the component of the network infrastructure is remote from the user device.

What is claimed is:

1. A method for configuring components of a network infrastructure, the method comprising:
determining a component of the network infrastructure, wherein the component is associated with values of configuration data;
generating an augmented reality representation of the component of the network infrastructure, the augmented reality representation including the component, the values of the configuration data of the component, and one or more connections between the component and other components of the network infrastructure;
overlaying the augmented reality representation on a camera feed, the camera feed associated with a camera of a user device;
receiving an instruction to modify the values of the configuration data of the component; and
sending an instruction to modify the values of the configuration data of the component.

2. The method of claim 1, wherein generating the augmented reality representation of the component of the network infrastructure is performed on a server remote from the user device.

3. The method of claim 2, further comprising establishing a persistent connection between the server and the user device, wherein the server monitors security information associated with a plurality of components of the network infrastructure.

4. The method of claim 3, further comprising transmitting, by the server to the user device, a notification in response to a security event.

5. The method of claim 4, wherein the notification includes information about the security event and a list of one or more remediation options.

6. The method of claim 3, further comprising transmitting, by the server to the user device, updated configuration data associated with the component of the network infrastructure.

7. The method of claim 1, further comprising determining a plurality of components of the network infrastructure, each component associated with a respective configuration data.

8. The method of claim 7, further comprising generating an augmented reality representation of the plurality of components of the network infrastructure, the augmented reality representation including each component of the plurality of components, the respective configuration data of each component, and one or more connections between each component and other components of the network infrastructure.

9. The method of claim 1, further comprising generating an augmented reality representation of a simulated network infrastructure.

10. The method of claim 1, wherein the component of the network infrastructure is remote from the user device.

11. A system for configuring components of a network infrastructure, the system comprising:
at least one processor; and
a memory storing instructions that, when executed by the at least one processor, cause the at least one processor to perform operations comprising:
determining a component of the network infrastructure, wherein the component is associated with values of configuration data;
generating an augmented reality representation of the component of the network infrastructure, the augmented reality representation including the component, the values of the configuration data of the component, and one or more connections between the component and other components of the network infrastructure;
overlaying the augmented reality representation on a camera feed, the camera feed associated with a camera of a user device;
receiving an instruction to modify the values of the configuration data of the component; and
sending an instruction to modify the values of the configuration data of the component.

12. The system of claim 11, wherein generating the augmented reality representation of the component of the network infrastructure is performed on a server remote from the user device.

13. The system of claim 12, the operations further comprising establishing a persistent connection between the server and the user device, wherein the server monitors security information associated with a plurality of components of the network infrastructure.

14. The system of claim 13, the operations further comprising transmitting, by the server to the user device, a notification in response to a security event.

15. The system of claim 14, wherein the notification includes information about the security event and a list of one or more remediation options.

16. The system of claim 13, the operations further comprising transmitting, by the server to the user device, updated configuration data associated with the component of the network infrastructure.

17. The system of claim 11, the operations further comprising determining a plurality of components of the network infrastructure, each component associated with a respective configuration data.

18. The system of claim 17, the operations further comprising generating an augmented reality representation of the plurality of components of the network infrastructure, the augmented reality representation including each component of the plurality of components, the respective configuration data of each component, and one or more connections between each component and other components of the network infrastructure.

19. The system of claim 11, the operations further comprising generating an augmented reality representation of a simulated network infrastructure.

20. The system of claim 11, wherein the component of the network infrastructure is remote from the user device.
